(19) United States
(12) Patent Application Publication
(10) Pub. No.: US 2015/0375662 A1
(43) Pub. Date: Dec. 31, 2015

(54) WIRELESS REMOTE-CONTROL HYDRAULIC PUMP MECHANISM FOR DUMP TRUCKS

(71) Applicant: Mao-Shen WANG, New Taipei (TW)

(72) Inventor: Mao-Shen WANG, New Taipei (TW)

(21) Appl. No.: 14/315,999

(22) Filed: Jun. 26, 2014

(51) Int. Cl. B60P 1/16; G08C 17/02; F15B 13/044

(52) U.S. Cl. CPC B60P 1/162; F15B 13/0442; G08C 17/02

(57) ABSTRACT

A wireless remote-control hydraulic pump mechanism comprising a hydraulic pump assembly, a remote-control device and a wireless transmitter is suitable for being installed on a dump truck to provide for the user to control the dumping by wireless remote-control operations, wherein the remote-control device in addition to wireless remote-control functions may further have optional wired manual remote-control functions and/or power voltage detection functions so that the user may select depending on actual situations to increase dumping safety of dump trucks.

### BACKGROUND OF THE INVENTION

1. Field of the Invention1 Technical Field

The invention relates to a wireless remote-control hydraulic pump mechanism, and more particularly, to a wireless remote-control hydraulic pump mechanism for dump trucks.

2. Description of Related Art

FIG. 1 shows a conventional dump truck 10 comprising an elevating body 11 for transporting loose material (such as sand or gravel), and the bottom of the elevating body 11 is hinged at the rear by a hinge 12 to the rear of a frame 13 of the dump truck 10 to achieve the purpose of dumping the material; a hydraulic cylinder 14 is configured at the front section of the frame 13, and the top of a piston rod 15 of the hydraulic cylinder 14 is connected to the bottom of the elevating body 11 by hinges (not shown in FIG. 1). When the piston rod 15 of the hydraulic cylinder 14 is extended, the elevating body 11 is elevated to a dumping position and the loose material is automatically dumped; when the piston rod 15 of the hydraulic cylinder 14 is retracted, the elevating body 11 is returned to a transporting position.

As shown in FIG. 1 and FIG. 2, the dump truck 10 is configured with a hydraulic pump assembly 30 and an automotive battery 80 to control the hydraulic cylinder 14 to extend or retract the piston rod 15; a manual controller 16 is configured between the hydraulic pump assembly 30 and the automotive battery 80, and a first pipeline 34 and a second pipeline 35 are configured between the hydraulic pump assembly 40 and the hydraulic cylinder 14, wherein one end of the first pipeline 34 is connected to a first chamber 14a of the hydraulic cylinder 14 and one end of the second pipeline 35 is connected to a second chamber 14b of the hydraulic cylinder 14.

The hydraulic pump assembly 30 at least comprises an oil reservoir 31, a hydraulic pump 32, and a solenoid valve 33, wherein the hydraulic pump 32 applies pressure on oil in the oil reservoir 31 and forces the oil to flow to the first pipeline 34 or the second pipeline 35; the solenoid valve 33 is a direction-controlling valve that controls the flow direction of the oil, and a 4/2-way valve as in FIG. 2 or a 4/3-way valve may be selected. By switching between ports of the solenoid valve 33, the oil pressurized by the hydraulic pump 32 may be selectively directed into the first pipeline 34 or the second pipeline 35 so that the piston rod 15 of the hydraulic cylinder 14 is extended or retracted, and the elevating body 11 is subsequently elevated to the dumping position or returned to the transporting position.

The electric power to activate the hydraulic pump 22 or the electric power to switch between ports of the solenoid valve 23 are both controlled by the manual controller 16 to be provided from the automotive battery 80. Therefore, conventional dump trucks 10 use manual controllers 15 to control the elevating of the elevating body 11 to the dumping position or the returning of the elevating body 11 to the transporting position.

However, since the manual controller 16 does not have a radio frequency (RF) receiver, only wired manual remote-control functions are provided and not wireless remote-control functions.

### SUMMARY OF THE PRESENT INVENTION

In view of the above, the main purpose of the present invention is to provide a wireless remote-control hydraulic pump mechanism for dump trucks comprising: a hydraulic pump assembly, comprising an oil reservoir, a hydraulic pump, and a solenoid valve, wherein the hydraulic pump applies pressure on oil in the oil reservoir and forces the oil to flow out a port of the solenoid valve after being activated; a remote-control device, configured with a power input cable as a power supply and a power output cable to provide electric power to the hydraulic pump and the solenoid valve, wherein the remote-control device controls transmission of electric power to the power output cable; and a wireless transmitter, wherein the remote-control device has wireless remote-control functions and further comprises: a microcontroller unit, which is an integrated circuit (IC) independently executing specific control functions, outputting a control signal according to an input signal; a radio frequency (RF) receiver, receiving a RF signal from the wireless transmitter and transmitting the received RF signal to the microcontroller unit; a relay actuated circuit, controlling electric power of the power output cable to activate the hydraulic pump, wherein the microcontroller unit controls the relay actuated circuit to provide electric power according to the input signal; and a solenoid valve actuated circuit, controlling electric power of the power output cable to switch between ports of the solenoid valve, wherein the microcontroller unit controls the solenoid valve actuated circuit to provide electric power according to the input signal.

The remote-control device further comprises a manual-control circuit and has both wireless remote-control functions and wired manual remote-control functions in a preferred embodiment.

The remote-control device further comprises a voltage detection circuit to detect a voltage of the power input cable in a preferred embodiment.

The remote-control device further comprises a display to display the detected voltage of the power input cable.

The invented wireless remote-control hydraulic pump mechanism may have the following advantages:
(1) It is suitable for installing on a dump truck and implementing automatic dumping operations;
(2) It possesses wireless remote-control functions, when installed on dump trucks, the user may implement dumping operations by wireless remote control with convenience; and
(3) In addition to the wireless remote-control functions, it has multi-purpose applicability by optionally possessing wired manual remote-control functions and/or power voltage detection functions, when installed on dump trucks, the user may select depending on actual situations to increase dumping safety for dump trucks.

### BRIEF DESCRIPTION OF THE DRAWINGS

FIG. 1 is a cross-sectional diagram of a conventional dump truck;

FIG. 2 is a schematic of a hydraulic cylinder and a hydraulic pump assembly used on the dump truck in FIG. 1;

FIG. 3 is a schematic of a wireless remote-control hydraulic pump mechanism according to an embodiment of the invention;

FIG. 4 is a circuit block diagram of the wireless remote-control hydraulic pump mechanism in FIG. 3 having wireless remote-control functions and wired manual remote-control functions;

FIG. 5 is a schematic of a wireless remote-control hydraulic pump mechanism according to another embodiment of the invention;

FIG. 6 is a circuit block diagram of the wireless remote-control hydraulic pump mechanism in FIG. 5 having only wireless remote-control functions;

FIG. 7 is a circuit block diagram of the wireless remote-control hydraulic pump mechanism having additional power voltage detection functions; and

FIG. 8 is a schematic of the wireless remote-control hydraulic pump mechanism comprising a display to display a detected voltage.

### DETAILED DESCRIPTION OF THE PREFERRED EMBODIMENT

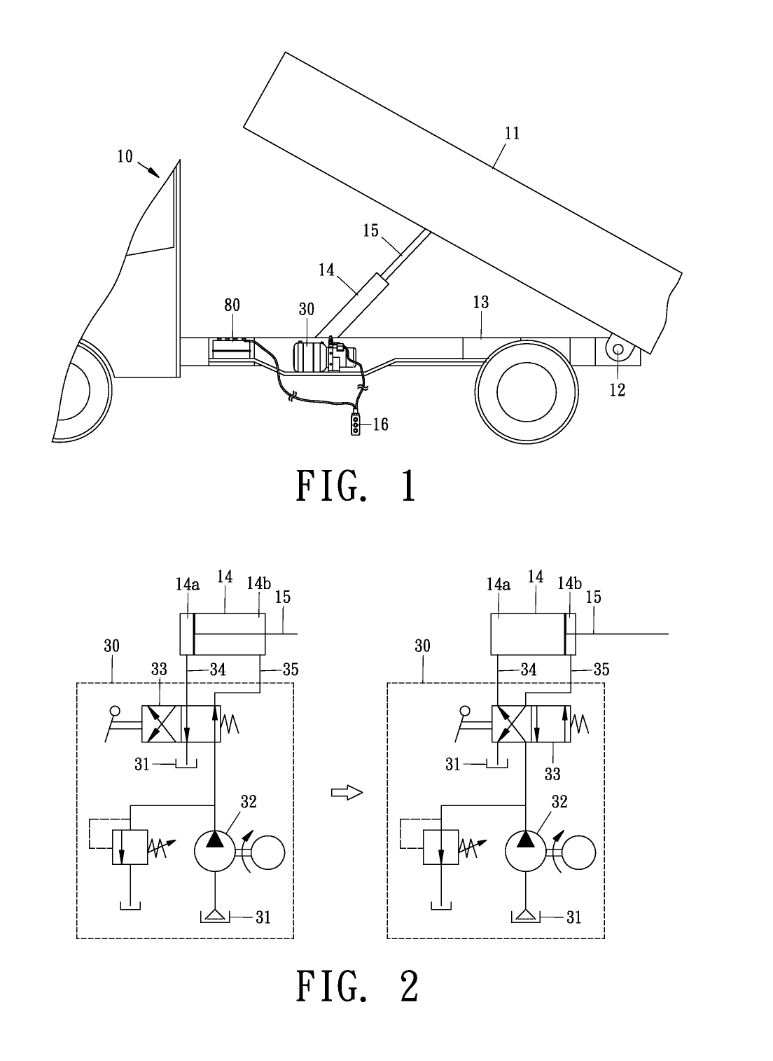

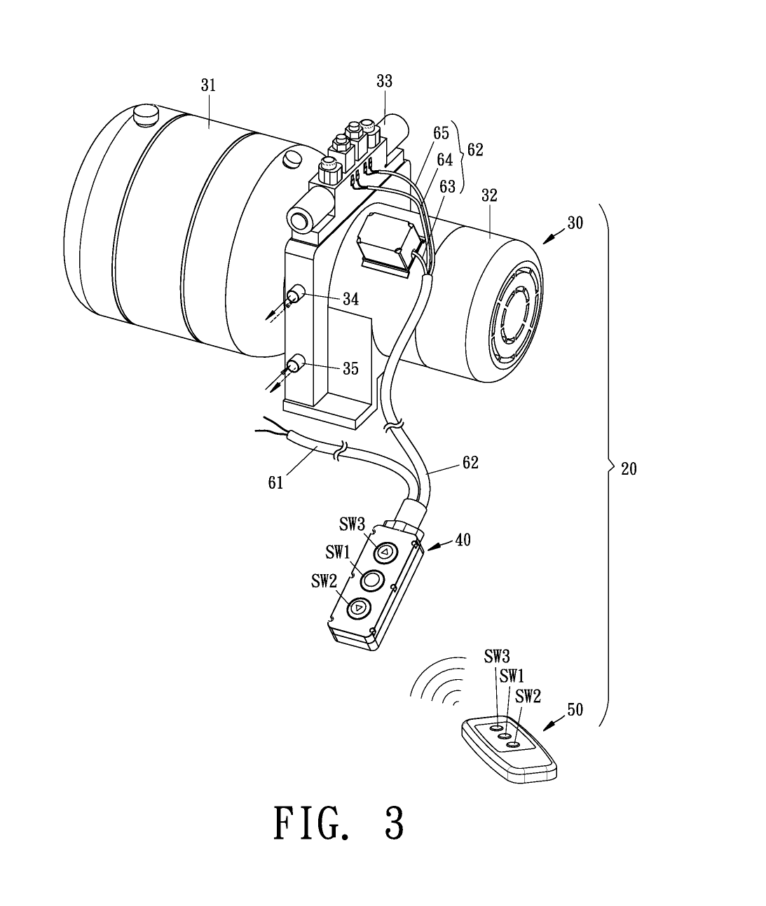

FIG. 3 shows an embodiment of a wireless remote-control hydraulic pump mechanism 20 installed on the dump truck 10 in FIG. 1 and mainly providing for the user to control the elevating of the elevating body 11 of the dump truck 10 to a dumping position or the returning of the elevating body 11 of the dump truck 10 to a transporting position by wireless remote-control operations.

As shown in FIG. 2 to FIG. 4, the wireless remote-control hydraulic pump mechanism 20 of the present invention comprises a hydraulic pump assembly 30, a remote-control device 40 and a wireless transmitter 50, wherein the hydraulic pump assembly 30 at least comprises an oil reservoir 31, a hydraulic pump 32, and a solenoid valve 33. For brevity, the specific structures of the components, the connection relationships between the components, and the functions of the hydraulic pump assembly 30 are described in above-mentioned related art and will not be repeated here.

The remote-control device 40 may have the function of providing power by wireless remote control and is configured with a power input cable 61 and a power output cable 62. During usage, the power input cable 61 is electrically connected to a 12V direct current (DC) power supply, and the power output cable 62 provides electric power to the hydraulic pump assembly 30. As shown in FIG. 1, the power input cable 61 may be connected to the automotive battery 80 which may act as the 12V DC power supply; the remote-control device 40 controls the transmission of the 12V DC power from the power input cable 61 to the power output cable 62.

When the solenoid valve 33 of the hydraulic pump assembly 30 is selected to be a 4/2-way valve, the power output cable 62 at least comprises two power lines, wherein the first power line 63 is electrically connected to the hydraulic pump 32 of the hydraulic pump assembly 30 and the second power line 64 is electrically connected to the solenoid valve 33 of the hydraulic pump assembly 30. When the solenoid valve 33 of the hydraulic pump assembly 30 is selected to be a 4/3-way valve, the power output cable 62 at least comprises three power lines, wherein the first power line 63 is electrically connected to the hydraulic pump 32 of the hydraulic pump assembly 30 and the second power line 64 and the third power line 65 are electrically connected to the solenoid valve 33 of the hydraulic pump assembly 30, respectively.

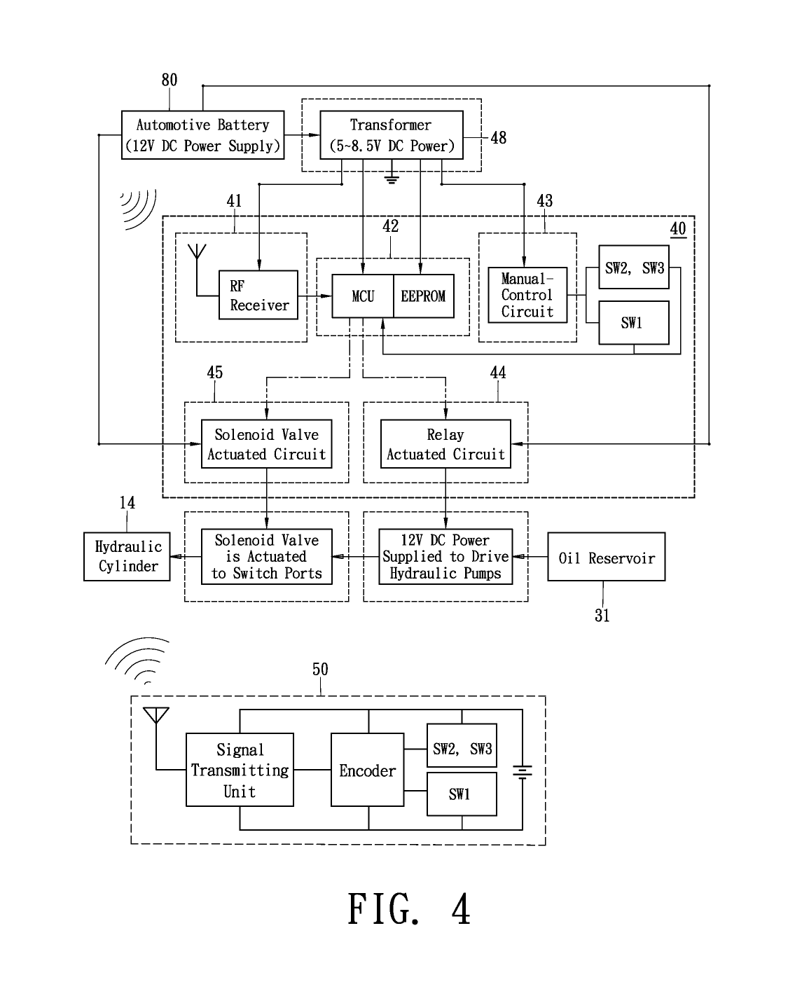

FIG. 3 and FIG. 4 show the remote-control device 40 according to an embodiment of the invention, wherein the remote-control device 40 has both wireless remote-control functions and wired manual remote-control functions and at least comprises a radio frequency (RF) receiver 41, a microcontroller unit (MCU) 42, a manual-control circuit 43, a relay actuated circuit 44, and a solenoid valve actuated circuit 45. The manual-control circuit 43 may comprise a pump activation switch SW1, an extension switch SW2 and a retraction switch SW3.

The remote-control device 40 further comprises a transformer 48, and when the power input cable 61 is connected to the automotive battery 80, the transformer 48 may provide 5˜8.5V power to the RF receiver 41, the MCU 42 and the manual-control circuit 43.

The MCU 42 of the remote-control device 40 is an integrated circuit (IC) independently executing specific control functions which integrates the related circuits of central processing unit (CPU), read-only memory (ROM) or electrically-erasable programmable read-only memory (EEPROM), random access memory (RAM), input/output (I/O) control circuit, clock time counter (CTC), etc. into a single chip, wherein the ROM or EEPROM of the MCU 42 is already saved with the control information inputted by the corresponding the RF receiver 41 and the manual-control circuit 43.

The RF receiver 41 receives an identification code and a RF signal transmitted from the wireless transmitter 50, and transmits the received identification code and RF signal to an input port of the MCU 42; after confirmation by the MCU 42, the inputted RF signal is then decoded into a corresponding control signal that is transmitted.

The manual-control circuit 43 receives switch control signals of the pump activation switch SW1, the extension switch SW2, and/or the retraction switch SW3 which are manually switched, and transmits the received switch control signals to the input port of the MCU 42; after confirmation by the MCU 42, the corresponding control signal is transmitted.

Therefore, the MCU 42 immediately transmits corresponding control signals to control the conduction status of the relay actuated circuit 44 and/or the solenoid valve actuated circuit 45 according to the information inputted by the RF receiver 41 and the manual-control circuit 43.

The relay actuated circuit 44 controls the access of the first power line 63 of the power output cable 62 to the 12V DC power. When the RF receiver 41 receives the signal of the pump activation switch SW1 transmitted by the remote wireless transmitter 50 or the manual-control circuit 43 receives the signal of the pump activation switch SW1 being manually switched, the MCU 42 controls the relay actuated circuit 44 corresponding to the inputted signal to conduct so that the first power line 63 is provided with the 12V DC power inputted from the power input cable 61 and activates the hydraulic pump 32 of the hydraulic pump assembly 30; the oil in the oil reservoir 31 is pressurized by the hydraulic pump 32 and directed into the first pipeline 34 or the second pipeline 35 via ports of the solenoid valve 33 to reach the hydraulic cylinder 14 in FIG. 1.

The solenoid valve actuated circuit 45 controls the access of the second power line 64 or the third power line 65 of the power output cable 62 to the 12V DC power. When the RF receiver 41 receives the signals of the extension switch SW2 or the retraction switch SW3 transmitted by the remote wireless transmitter 50 or the manual-control circuit 43 receives the signals of the extension switch SW2 or the retraction switch SW3 being manually switched, the MCU 42 controls the solenoid valve actuated circuit 45 corresponding to the inputted signal to conduct so that the second power line 64 or the third power line 65 is provided with the 12V DC power inputted from the power input cable 61 and switches between ports of the solenoid valve 33 of the hydraulic pump assembly 30; the pressurized oil originally flowing in the first pipeline 34 may be directed into the second pipeline 35 to reach the hydraulic cylinder 14 in FIG. 1 and vice versa.

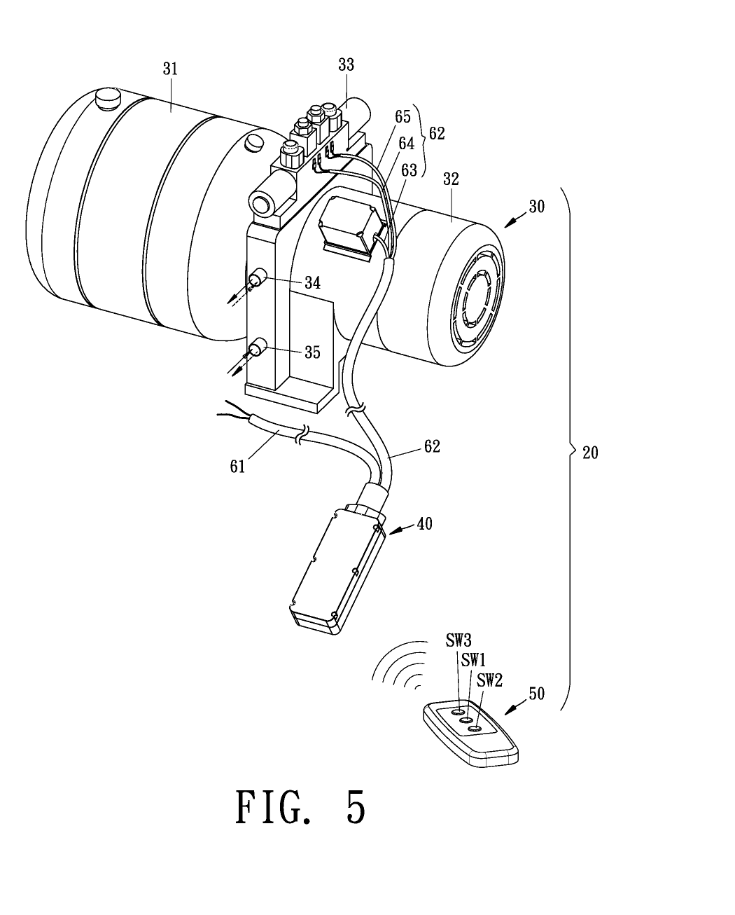

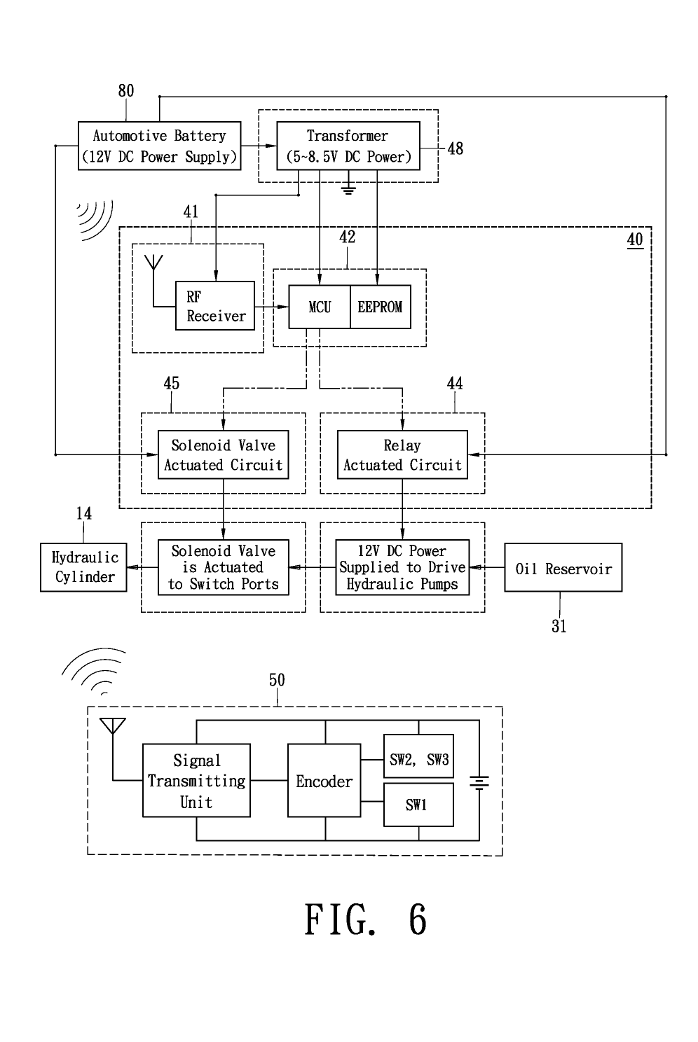

FIG. 5 and FIG. 6 show the remote-control device 40 according to a second embodiment of the invention, wherein the remote-control device 40 only has wireless remote-control functions and at least comprises a radio frequency (RF) receiver 41, a microcontroller unit (MCU) 42, a relay actuated circuit 44 and a solenoid valve actuated circuit 45 without a manual-control circuit 43. The wireless remote-control operations of the remote-control device 40 are described in above and will not be repeated here for brevity.

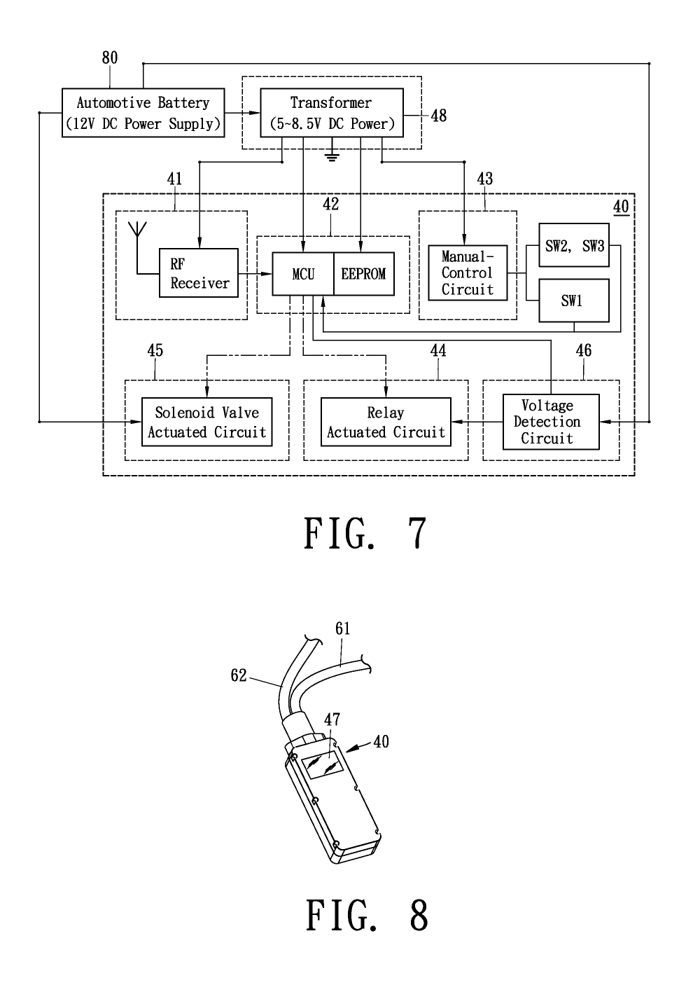

FIG. 7 shows the remote-control device 40 according to a third embodiment of the invention, wherein the remote-control device 40 may be selected to have both wireless remote-control functions and wired manual remote-control functions or only wireless remote-control functions while further having power voltage detection functions. The remote-control device 40 at least comprises a radio frequency (RF) receiver 41, a microcontroller unit (MCU) 42, a relay actuated circuit 44, a solenoid valve actuated circuit 45 and a voltage detection circuit 46.

The voltage detection circuit 46 of the remote-control device 40 detects a voltage of the power input cable 61 and the MCU 42 of the remote-control device 40 suspends or prohibits the activation of the hydraulic pump assembly 30 if the detected voltage is not within a normal operation range (e.g., when the detected voltage is lower than 12V).

As shown in FIG. 8, the remote-control device 40 further comprises a display 47 of which the displayed messages are controlled by the MCU 42, and displays the detected voltage of the power input cable 61 so that the user may understand the voltage status of the power supply. Therefore, by installing the wireless remote-control hydraulic pump mechanism 20 on the dump truck 10 in FIG. 1, dumping safety of the dump truck 10 may be enhanced in addition to having wireless remote-control functions.

What is claimed is:

1. A wireless remote-control hydraulic pump mechanism for dump trucks, comprising:
a hydraulic pump assembly, comprising an oil reservoir, a hydraulic pump and a solenoid valve, wherein the hydraulic pump applies pressure on oil in the oil reservoir and forces the oil to flow out a port of the solenoid valve after being activated;
a remote-control device, configured with a power input cable as a power supply and a power output cable to provide electric power to the hydraulic pump and the solenoid valve, wherein the remote-control device controls transmission of electric power to the power output cable; and
a wireless transmitter,
wherein the remote-control device has wireless remote-control functions and further comprises:
a microcontroller unit, which is an integrated circuit (IC) independently executing specific control functions and outputting a control signal according to an input signal;
a radio frequency (RF) receiver, receiving a RF signal from the wireless transmitter and transmitting the received RF signal to the microcontroller unit;
a relay actuated circuit, controlling electric power of the power output cable to activate the hydraulic pump, wherein the microcontroller unit controls the relay actuated circuit to provide electric power according to the input signal; and
a solenoid valve actuated circuit, controlling electric power of the power output cable to switch between ports of the solenoid valve, wherein the microcontroller unit controls the solenoid valve actuated circuit to provide electric power according to the input signal.

2. The wireless remote-control hydraulic pump mechanism for dump trucks as claimed in claim 1, wherein the remote-control device further comprises a manual-control circuit and has both wireless remote-control functions and wired manual remote-control functions.

3. The wireless remote-control hydraulic pump mechanism for dump trucks as claimed in claim 1, wherein the remote-control device further comprises a voltage detection circuit to detect a voltage of the power input cable.

4. The wireless remote-control hydraulic pump mechanism for dump trucks as claimed in claim 2, wherein the remote-control device further comprises a voltage detection circuit to detect a voltage of the power input cable.

5. The wireless remote-control hydraulic pump mechanism for dump trucks as claimed in claim 3, wherein the remote-control device further comprises a display to display the detected voltage of the power input cable.

6. The wireless remote-control hydraulic pump mechanism for dump trucks as claimed in claim 4, wherein the remote-control device further comprises a display to display the detected voltage of the power input cable.
